(19) United States
(12) Patent Application Publication
(10) Pub. No.: US 2026/0087667 A1
(43) Pub. Date: Mar. 26, 2026

(54) Solar Azimuth Estimation Method and System Based on Multi-Channel Feature Enhancement and Region-Aware Attention

(71) Applicant: Hangzhou City University, Hangzhou (CN)

(72) Inventors: Zhenbing Qiu, Hangzhou (CN); Yanjun Li, Hangzhou (CN); Jun Zhao, Hangzhou (CN); Weijun Zhou, Hangzhou (CN); Chenhuan Cui, Hangzhou (CN); Lan Gao, Hangzhou (CN)

(21) Appl. No.: 19/403,620

(22) Filed: Nov. 28, 2025

(30) Foreign Application Priority Data
Nov. 10, 2025 (CN) 202511636223.1

(51) Int. Cl. G06T 7/73; G01C 21/02; G06T 5/92; G06V 10/42; G06V 10/60; G06V 10/766; G06V 10/77; G06V 10/80; G06V 10/82

(52) U.S. Cl. CPC G06T 7/74; G01C 21/02; G06T 5/92; G06V 10/431; G06V 10/60; G06V 10/766; G06V 10/7715; G06V 10/806; G06V 10/82; G06T 2207/20081; G06T 2207/20084

(57) ABSTRACT

The present invention relates to a solar azimuth estimation method and system based on multi-channel feature enhancement and region-aware attention, belonging to the technical field of intelligent navigation for low-altitude economy unmanned systems. Aiming at the problem of decreased accuracy in solar azimuth estimation based on polarization images under complex cloud cover conditions, the present invention proposes a deep learning framework integrating multi-channel features and direction-aware attention. First, based on polarization light field information acquired by a division-of-focal-plane polarization camera, a three-channel composite input feature composed of a polarization intensity map, an adaptive threshold gradient map, and high-frequency residual edge information is constructed. Second, a ResNet backbone network embedded with a squeeze-and-excitation mechanism is adopted, and a direction-aware polarization attention module is introduced to achieve adaptive fusion of multi-scale features through luminance guidance, deep feature enhancement, and a gradient edge branch.

### TECHNICAL FIELD

The present invention belongs to the technical field of intelligent navigation for low-altitude economy unmanned systems, and specifically relates to a solar azimuth estimation method and system based on multi-channel feature enhancement and region-aware attention.

### BACKGROUND

Achieving continuous and precise autonomous navigation for unmanned systems in complex environments is a key and challenging research focus. Global Navigation Satellite Systems (GNSS) are prone to signal attenuation or interruption in indoor, canyon, dense forest, or interfered environments, while Inertial Navigation Systems (INS) suffer from error accumulation over time. Navigation methods relying on environmental features, such as visual SLAM, exhibit instability in dynamic scenes, weakly textured environments, or under drastic lighting variations. Therefore, developing auxiliary or alternative navigation solutions that do not depend on external signals and are suitable for complex weather conditions is of significant value.

As a bionic navigation technology, polarized light navigation provides directional and attitude references for carriers by detecting the stable polarization distribution pattern formed in the sky due to atmospheric scattering of sunlight. It offers advantages such as being passive, free from cumulative errors, and resistant to interference. Existing polarized light orientation methods primarily rely on point sensors or imaging polarization cameras to obtain polarization information, and then invert the solar azimuth by calculating the Angle of Polarization (AoP) and Degree of Polarization (DoP). However, in practical applications, especially under adverse weather conditions such as cloudy or hazy skies, cloud occlusion and aerosol scattering significantly reduce the sky polarization degree and disrupt the symmetry and consistency of the polarization pattern, leading to a sharp decline in the performance of traditional physical model-based or extremum search-based solar azimuth estimation methods.

In recent years, some studies have attempted to introduce deep learning to improve the robustness of polarization navigation. For example, certain works employ structures such as SE-ResNet to fuse AoP, DoP, and intensity information for solar vector estimation, but their generalization capability remains limited when facing complex degradation caused by real sky clouds. Other research enhances polarization image quality via deep learning to improve heading estimation accuracy, but most focus solely on azimuth estimation and fail to fully utilize imaging polarization information for high-precision joint estimation of the full solar vector (azimuth and elevation angles). Moreover, existing methods lack sufficient ability to distinguish weak effective signals from complex noise and edge features in polarization images under cloudy conditions at the feature extraction level, and they lack specialized network structure designs tailored to polarization characteristics and direction awareness, which limits their navigation accuracy and application scope in complex meteorological conditions.

Therefore, there is an urgent need for a high-precision solar azimuth estimation method that can effectively cope with complex sky conditions such as cloudy weather, fully utilize multi-dimensional information from polarization images, and perform intelligent feature enhancement and selection, so as to enhance the navigation reliability of unmanned systems in environments without reliable GNSS signals.

### SUMMARY

Aiming at the problem of decreased accuracy in solar azimuth estimation based on polarization images under complex cloud cover conditions, a deep learning framework integrating multi-channel features and direction-aware attention is proposed. First, based on the polarization light field information acquired by a division-of-focal-plane polarization camera, a three-channel composite input feature composed of a polarization intensity map, an adaptive threshold gradient map, and high-frequency residual edge information is constructed. Second, a ResNet backbone network embedded with a squeeze-and-excitation mechanism is adopted, and a direction-aware polarization attention module is introduced to achieve adaptive fusion of multi-scale features through luminance guidance, deep feature enhancement, and a gradient edge branch. Third, learnable Softmax weights are utilized to dynamically fuse multi-branch features, and a direction constraint mechanism is introduced in the output layer to explicitly optimize the estimation results of the solar azimuth and elevation angles.

To achieve the above objectives, the technical solution of the present invention is as follows:

A solar azimuth estimation method and system based on multi-channel feature enhancement and region-aware attention, comprising the following steps:

Step 1: Establish a three-channel polarization image feature construction module, including an original luminance channel, a luminance contrast enhancement channel, and a high-frequency residual edge channel.

Step 2: For the module in Step 1, use ResNet-50 (Residual Network-50) as the backbone network to establish a squeeze-and-excitation enhanced residual backbone network architecture.

Step 3: On the basis of Step 2, design a solar region-aware attention module.

Step 4: On the basis of Step 3, design an output regression layer and a continuous angle prediction module.

Step 5: Design a loss function.

Furthermore, in said Step 1:

The original polarization degree-based polarization image is expanded into a three-channel tensor to encode directional cues. The input image X∈ [symbol] ^{3×H×W} (H, W represent height and width) comprises: (1) a normalized original polarization image P, (2) an adaptive threshold gradient channel R, used to highlight luminance and polarization changes, and (3) a high-frequency residual edge channel F, which retains small-scale polarization changes by suppressing low-frequency illumination.

The adaptive threshold gradient channel is calculated by combining Gaussian adaptive thresholding with Sobel magnitude edge response:

$${I}_{ATG} ( u , v ) = Norm ( {Thresh}_{adaptive} ( I ( u , v ) ) ⊕ Sobel ( I ( u , v ) ) )$$

where I(u,v) represents the intensity value of the input image at pixel coordinates (u, v), and I_{ATG}(u,v) represents the intensity value after the adaptive threshold gradient operation. Sobel(⋅) denotes the gradient magnitude of the image calculated based on the Sobel operator; ⊕ denotes the fusion of gradient information; Thresh_{adaptive}(I(u,v) provides block-based luminance contrast enhancement, binarizing the image; Norm(⋅) denotes a normalization operation.

The high-frequency residual edge channel enhances fine-scale directional cues by removing low-frequency illumination via Gaussian subtraction:

$${I}_{HFRE} ( u , v ) = Norm ( v \cdot [ I ( u , v ) - ( {G}_{σ} ⋆ I ) ( u , v ) ] )$$

where * denotes convolution with the Gaussian kernel G_{σ}, σ is the standard deviation, and v=2.0 is a scaling factor. This process preserves edge variations caused by polarization, which remain detectable even when clouds suppress the global polarization degree. I_{HFRE}(u,v) represents the intensity value after the high-frequency residual edge channel operation.

Furthermore, in said Step 2:

In the initial feature extraction stage, perform convolution (Conv1), batch normalization (BN), and rectified linear unit (ReLU) activation operations sequentially on the input polarization image features F_{\text{early}} to extract basic luminance and polarization pattern features. Then, introduce an early direction-aware polarization attention module \text{DAPA}_{\text{early}} to enhance the spatial directional response capability of the polarization pattern. After max pooling (MaxPool), early enhanced features are obtained. The structural relationship is expressed as:

$${F}_{early} \to Conv 1 + BN + Re LU \to {DAPA}_{early} \to MaxPool$$

where F_{early} represents the early feature tensor of the input image; Conv1 denotes the first convolutional layer operation for extracting local luminance and polarization pattern distributions; BN denotes batch normalization operation for stabilizing network training and accelerating convergence; ReLU denotes the rectified linear unit activation function for introducing nonlinear feature representation capability; DAPA_{early} denotes the early Direction-aware Polarization Attention module, which enhances polarization direction features through direction-selective weight calculation; MaxPool denotes the max pooling operation for down-sampling and retaining significant feature regions.

After the above early feature enhancement, the feature map F_{mid} enters the backbone network for deep polarization feature extraction. The backbone network adopts a residual structure (ResNet-50), and embeds a mid-term polarization attention module DAPA_{mid} after the Layer 1 stage to further strengthen the hierarchical response of polarization structures. The structural relationship is expressed as:

$${F}_{mid} \to Layer 1 \to {DAPA}_{mid} \to Layer 2 \to Layer 3 \to Layer 4$$

Where F_{mid} represents the mid-term feature tensor input to the residual network; Layer1-Layer4 represent the four hierarchical modules in the residual network; DAPA_{mid} denotes the mid-term Direction-aware Polarization Attention module, used to selectively enhance polarization direction features and suppress noise interference in the mid-level feature space.

A channel attention module SE (Squeeze-and-Excitation) is further embedded in each residual block from Layer 1 to Layer 4 to achieve adaptive recalibration of channel-level features. It is expressed as follows:

$${X}_{se} = σ ( {W}_{2} , δ ( {W}_{1} GAP ( X ) ) ) ⊙ X$$

where X represents the input feature tensor; GAP(⋅) denotes the global average pooling operation for extracting global statistical features of each channel; W₁ and W₂ represent the weight matrices of two fully connected layers, respectively; δ(⋅) denotes the ReLU activation function; σ(⋅) denotes the Sigmoid activation function; ⊙ denotes the Hadamard product; Xₛₑ represents the output feature tensor after channel recalibration.

Through the synergistic effect of the above modules, multi-level feature enhancement and dynamic weighting of polarization images are achieved, enabling the system to accurately extract solar azimuth-related features even in complex cloud environments, thereby improving the robustness and accuracy of solar azimuth estimation.

Furthermore, in said Step 3:

On the basis of the multi-scale features extracted in Step 2, a solar region-aware attention module is designed. This module consists of a luminance guidance branch, a direction recalibration branch, and a polarization gradient perception branch, (used to achieve joint enhancement of polarization features and spatial structure features).

The input feature tensor is denoted as F∈ [symbol] ^{C×H×W}, where C is the number of channels, H and W are the height and width of the feature map, respectively. The outputs of the three branches are denoted as M₁(F), M₂(F), and M₃(F), and their core computational forms are as follows:

$${M}_{1} ( F ) = {f}_{1} ( F ) , {M}_{2} ( F ) = {f}_{2} ( F ) , {M}_{3} ( F ) = {f}_{3} ( F )$$

where, f₁(⋅) represents a luminance-guided channel weighting function for enhancing global illumination response; f₂(⋅) represents a direction-sensitive channel recalibration function for improving the angular resolution capability of local features; f₃(⋅) represents a polarization gradient perception function for capturing spatial variation information of the polarization angle.

The final output of the module is denoted as

$${F}^{′} = Φ ( {M}_{1} ( F ) , {M}_{2} ( F ) , {M}_{3} ( F ) )$$

where, Φ(⋅) represents a multi-branch fusion function for synthesizing different feature responses to generate a region-aware enhanced feature map, thereby improving the accuracy and stability of solar azimuth estimation.

Furthermore, in said Step 4:

An output regression layer and a continuous angle prediction module are designed to extract global directional information from the fused high-dimensional feature map and output continuous estimation results for the solar azimuth and elevation angles. The processing comprises the following steps:

(1) Perform a global average pooling (GAP) operation on the region-aware attention-enhanced feature map \hat{X}_{L}∈ [symbol] ^{d×H×W} to compress the spatial feature distribution and generate a compact global feature representation:

$${f}_{global} = \frac{1}{H \cdot W} {\sum }_{i = 1}^{H} {\sum }_{j = 1}^{W} {\hat{X}}_{L} [ i , j ] ∈ {ℝ}^{d}$$

where d is the number of channels.

(2) Input the global feature vector f_{global} into a nonlinear regression network composed of multi-layer fully connected mappings to achieve joint continuous prediction of the azimuth and elevation angles:

$$\hat{y} = {W}_{3} \cdot δ ( {W}_{2} \cdot δ ( {W}_{1} \cdot {f}_{global} ) ) = ( {\hat{ϕ}}_{azimuth} , {\hat{θ}}_{elevation} )$$

where, δ(⋅) represents the activation function, W₁, W₂, W₃ are learnable weight matrices, and \hat{φ}_{azimuth},\hat{φ}_{azimuth} represent the estimated values of the solar azimuth and elevation angles, respectively.

In Step 5, a continuous angle regression loss function is designed for the network training phase to minimize the deviation between the predicted output and the true solar azimuth.

Advantages of the Invention compared to Prior Art:

By introducing a multi-branch feature enhancement module incorporating luminance guidance, direction recalibration, and polarization gradient perception, the present invention can simultaneously capture global luminance information, local directional features, and polarization angle gradient variations in polarization images, thereby fully mining features related to the solar region and improving the accuracy of solar azimuth extraction. The adopted region-aware attention module selectively enhances polarization features in key regions, helping to suppress interference from clouds and illumination variations, improving responsiveness to the solar region, and achieving robust azimuth estimation. By combining polarization information, luminance, and local gradient features, the invention maintains high-precision solar azimuth estimation even under cloudy conditions, illumination changes, and complex sky backgrounds, significantly outperforming traditional methods based on single luminance or color features. The proposed multi-channel feature enhancement and region-aware attention framework features a modular design, allowing easy integration into different UAV or ground navigation systems, while being compatible with other multi-modal sensor data fusion to enhance the overall positioning robustness of the system.

### BRIEF DESCRIPTION OF THE DRAWINGS

FIG. 1 is a design flowchart of a solar azimuth estimation method based on multi-channel feature enhancement and region-aware attention according to the present invention.

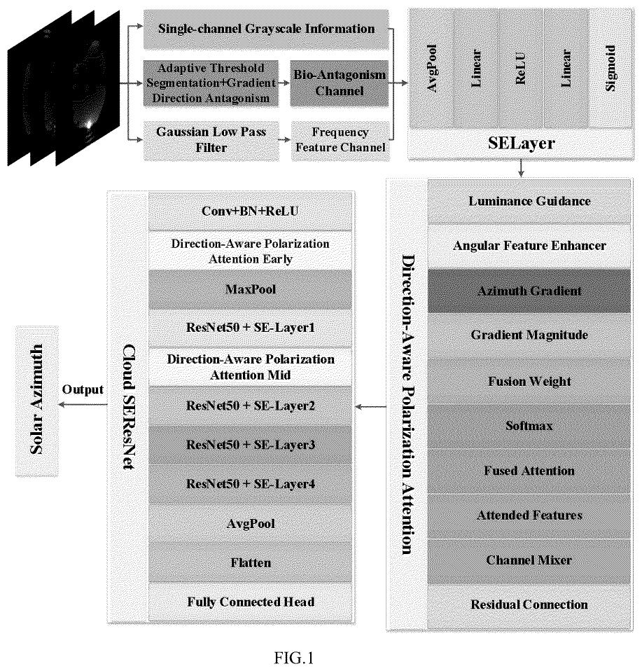

Content not described in detail in this specification belongs to the prior art well-known to those skilled in the art.

1. A solar azimuth estimation method and system based on multi-channel feature enhancement and region-aware attention, characterized by comprising the following steps:
Step 1: establishing a three-channel polarization image feature construction module, including an original luminance channel, a luminance contrast enhancement channel, and a high-frequency residual edge channel;
Step 2: for the module in Step 1, using ResNet-50 as the backbone network to establish a squeeze-and-excitation enhanced residual backbone network architecture;
Step 3: on the basis of Step 2, designing a solar region-aware attention module;
Step 4: on the basis of Step 3, designing an output regression layer and a continuous angle prediction module;
Step 5: designing a loss function.

2. The method and system according to claim 1, characterized in that in said Step 1:
the original polarization degree-based polarization image is expanded into a three-channel tensor to encode directional cues, the input image X∈ [symbol] ^{3×H×W} (H, W represent height and width) comprising: (1) a normalized original polarization image P, (2) an adaptive threshold gradient channel R, used to highlight luminance and polarization changes, and (3) a high-frequency residual edge channel F, which retains small-scale polarization changes by suppressing low-frequency illumination; the adaptive threshold gradient channel is calculated by combining Gaussian adaptive thresholding with Sobel magnitude edge response:
$${I}_{ATG} ( u , v ) = Norm ( {Thresh}_{adaptive} ( I ( u , v ) ) ⊕ Sobel ( I ( u , v ) ) )$$
where (I(u,v) represents the intensity value of the input image at pixel coordinates (u, v), and I_{ATG}(u,v) represents the intensity value after the adaptive threshold gradient operation; Sobel(⋅) Sobel(⋅) denotes the gradient magnitude calculated based on the Sobel operator; ⊕ denotes the fusion of gradient information; Thresh_{adaptive}(I(u,v)) provides block-based luminance contrast enhancement, binarizing the image; Norm(⋅) denotes a normalization operation; the high-frequency residual edge channel enhances fine-scale directional cues by removing low-frequency illumination via Gaussian subtraction:
$${I}_{HFRE} ( u , v ) = Norm ( v , [ ( I ( u , v ) - ( {G}_{σ} * I ) ( u , v ) ] )$$
where * denotes convolution with the Gaussian kernel Gσ, σ is the standard deviation, and v=2.0 is a scaling factor; this process preserves edge variations caused by polarization, which remain detectable even when clouds suppress the global polarization degree; I_{HFRE}(u,v) represents the intensity value after the high-frequency residual edge channel operation.

3. The method and system according to claim 2, characterized by comprising a multi-layer polarization feature enhancement process based on convolutional feature extraction and attention mechanism fusion, the structural flow being as follows: in the initial feature extraction stage, performing convolution (Conv1), batch normalization (BN), and rectified linear unit (ReLU) activation operations sequentially on the input polarization image features F_{early} to extract basic luminance and polarization pattern features; subsequently introducing an early direction-aware polarization attention module DAPA_{early} to enhance the spatial directional response capability of the polarization pattern; obtaining early enhanced features after max pooling (MaxPool); the structural relationship is expressed as:
$${F}_{early} \to Conv 1 + B N + R e L U \to D A P {A}_{early} \to MaxPool$$
where F_{early} represents the early feature tensor of the input image; Conv1 denotes the first convolutional layer operation for extracting local luminance and polarization pattern distributions; BN denotes batch normalization operation for stabilizing network training and accelerating convergence; ReLU denotes the rectified linear unit activation function for introducing nonlinear feature representation capability; DAPA_{early} denotes the early Direction-aware Polarization Attention module, which enhances polarization direction features through direction-selective weight calculation; MaxPool denotes the max pooling operation for down-sampling and retaining significant feature regions; after the above early feature enhancement, the feature map I′mid enters the backbone network for deep polarization feature extraction; the backbone network adopts a residual structure (ResNet-50), and embeds a mid-term polarization attention module DAPA_{mid}after the Layer 1 stage to further strengthen the hierarchical response of polarization structures; the structural relationship is expressed as:
$${F}_{mid} \to Layer 1 \to D A P {A}_{mid} \to Layer 2 \to Layer 3 \to Layer 4$$
where F_{mid} represents the mid-term feature tensor input to the residual network; Layer1-Layer4 represent the four hierarchical modules in the residual network; DAPA_{mid} denotes the mid-term Direction-aware Polarization Attention module, used to selectively enhance polarization direction features and suppress noise interference in the mid-level feature space; a channel attention module SE (Squeeze-and-Excitation) is further embedded in each residual block from Layer 1 to Layer 4 to achieve adaptive recalibration of channel-level features, expressed as follows:
$${X}_{se} = σ ( {W}_{2} , δ ( {W}_{1} G A P ( X ) ) ) ⊙ X$$
where X represents the input feature tensor; GAP(⋅) denotes the global average pooling operation for extracting global statistical features of each channel; W_1 and W_2 represent the weight matrices of two fully connected layers, respectively; σ(⋅) denotes the ReLU activation function; σ(⋅) denotes the Sigmoid activation function; └ denotes the Hadamard product; Xₛₑ represents the output feature tensor after channel recalibration; through the synergistic effect of the above modules, multi-level feature enhancement and dynamic weighting of polarization images are achieved, enabling the system to accurately extract solar azimuth-related features in complex cloud environments, thereby improving the robustness and accuracy of solar azimuth estimation.

4. The method and system according to claim 3, characterized in that in said Step 3, on the basis of the multi-scale features extracted in Step 2, a solar region-aware attention module is designed, said module consisting of a luminance guidance branch, a direction recalibration branch, and a polarization gradient perception branch, used to achieve joint enhancement of polarization features and spatial structure features; wherein, the input feature tensor is denoted as X∈ [symbol] ^{C×H×W}, where C is the number of channels, H and W are the height and width of the feature map, respectively; the outputs of the three branches are denoted as M₁(F),M₂(F) and M₃(F), and their core computational forms are as follows:
$${M}_{1} ( F ) = {f}_{1} ( F ) , {M}_{2} ( F ) = {f}_{2} ( F ) , {M}_{3} ( F ) = {f}_{3} ( F )$$
where, f₁(⋅) represents a luminance-guided channel weighting function for enhancing global illumination response; f₂(⋅) represents a direction-sensitive channel recalibration function for improving the angular resolution capability of local features; f₃(⋅) represents a polarization gradient perception function for capturing spatial variation information of the polarization angle; the final output of the module is denoted as
$$F = Φ ( {M}_{1} ( F ) , {M}_{2} ( F ) , {M}_{3} ( F ) )$$
where, Φ(⋅) represents a multi-branch fusion function for synthesizing different feature responses to generate a region-aware enhanced feature map, thereby improving the accuracy and stability of solar azimuth estimation.

5. The method and system according to claim 4, characterized in that in said Step 4, an output regression layer and a continuous angle prediction module are designed to extract global directional information from the fused high-dimensional feature map and output continuous estimation results for the solar azimuth and elevation angles; the processing comprises the following steps:
(1) performing a global average pooling (GAP) operation on the region-aware attention-enhanced feature map \hat{X}_{L}∈ [symbol] ^{d×H×W} to compress the spatial feature distribution and generate a compact global feature representation:
$${f}_{global} = \frac{1}{H \cdot W} {\sum }_{i = 1}^{H} {\sum }_{j = 1}^{W} {\hat{X}}_{L} [ i , j ] ∈ {ℝ}^{d}$$
where d is the number of channels;
(2) inputting the global feature vector f_{global} into a nonlinear regression network composed of multi-layer fully connected mappings to achieve joint continuous prediction of the azimuth and elevation angles:
$$\hat{y} = {W}_{3} \cdot δ ( {W}_{2} \cdot δ ( {W}_{1} \cdot {f}_{global} ) ) = ( {\hat{ϕ}}_{azimuth} , {\hat{θ}}_{elevation} )$$
where, δ(⋅) represents the activation function, W_1, W_2, W_3 are learnable weight matrices, and \hat{φ}_{azimuth}, \hat{θ}_{azimuth} elevation represent the estimated values of the solar azimuth and elevation angles, respectively; through the above structural design, modeling of global correlations of polarization features and continuous mapping in spatial angles are achieved, thereby improving azimuth estimation accuracy and stability under complex illumination and cloud interference conditions.

6. The method and system according to claim 5, characterized in that in said Step 5, a continuous angle regression loss function is designed for the network training phase to minimize the deviation between the predicted output and the true solar azimuth; it is defined as follows:
$${L}_{train} = \frac{1}{N} {\sum }_{i = 1}^{N} ‖ {\hat{y}}_{i} - \frac{{y}_{i}}{10} ‖$$
where
$${\hat{y}}_{i} = [ {\hat{ϕ}}_{azimuth}^{( i )} , {\hat{θ}}_{elevation}^{( i )} ]$$
represents the network prediction result for the i-th input where sample,
$${y}_{i} = [ {\hat{ϕ}}_{azimuth}^{( i )} , {\hat{θ}}_{elevation}^{( i )} ]$$
represents the corresponding true solar azimuth and elevation angles, and N is the total number of samples in the training batch; through this loss design, joint regression optimization of the azimuth and elevation angles is achieved, enhancing the model's learning stability in the continuous angle space and its adaptive capability to complex illumination changes, thereby effectively improving solar azimuth estimation accuracy and convergence efficiency.
